(19) United States
(12) Patent Application Publication
(10) Pub. No.: US 2025/0190815 A1
(43) Pub. Date: Jun. 12, 2025

(54) AUTOMATED GUIDANCE FOR MACHINE UNLEARNING

(71) Applicant: INTERNATIONAL BUSINESS MACHINES CORPORATION, Armonk, NY (US)

(72) Inventors: Anisa Halimi, Dublin (IE); Muhammad Zaid Hameed, Dublin (IE); Ambrish Rawat, Dublin (IE); Killian Levacher, Dublin (IE)

(21) Appl. No.: 18/531,514

(22) Filed: Dec. 6, 2023

(51) Int. Cl. G06N 3/0985; G06N 3/0475

(52) U.S. Cl. CPC G06N 3/0985; G06N 3/0475

(57) ABSTRACT

Generating performance metrics and recommendations to improve an unlearned model includes executing an unlearning algorithm to expunge the influence on a machine learning model of a selected sample of the machine learning model's training dataset. Executing the unlearning algorithm creates an unlearned model. Performance metrics are generated by a metrics generator for the unlearned model and the machine learning model. Based on the performance metrics, an unlearning analysis is generated by a comparator comparing the performances of the unlearned model and machine learning model. A recommender, based on the unlearning analysis, generates a recommendation recommending a revision to the unlearned model in response to detecting a deviation of more than a predetermined threshold of one or more of the performance metrics of the unlearned model from one or more of the performance metrics of the machine learning model. An evaluator generates an unlearning evaluation of the unlearned model.

### BACKGROUND

This disclosure relates to machine learning and, more particularly, to expunging selected data used to train a machine learning model and eliminating the influence of expunged data on predictions generated by the model.

Machine learning encompasses a broad range of techniques for making predictions (e.g., classification, regression, clustering). Whether through supervised, semi-supervised, or unsupervised learning, machine learning models learn to make predictions based on data. While machine learning is relatively new technology, even newer are technologies pertaining to machine “unlearning”—that is, removing select elements of a training set and causing a trained model to “forget” or unlearn the effects of the elements removed. Machine unlearning is also known as selective forgetting, data deletion, and scrubbing.

Impetus for the increasing interest in machine unlearning stems from several considerations. One consideration is security and reliability. Machine unlearning can be a safeguard against threats such as backdoor attacks in which an attacker attempts to manipulate a small portion of the training data, thus poisoning the model and allowing the attacker to gain unauthorized access to a system or to cause the model to make erroneous predictions. Another consideration is fairness. Machine unlearning can be used to ensure that predictions are not unfairly biased. Still another, increasingly important consideration is privacy. A growing number of legislators around the world have enacted or are expected to enact regulations giving users the “right to be forgotten.”

Regulations such as the European Union's General Data Protection Regulation (GDPR), the California Consumer Privacy Act (CCPA), the Act on the Protection of Personal Information (APPI), and Canada's proposed Consumer Privacy Protection Act (CPPA) compel the deletion of private information. Private information includes data such as personal data, voice renderings, and images that, in a legal sense, is owned by an individual. Such data is distinct from public data, which is considered to lie in the public domain and thus freely usable by all. Personal data typically requires the data owner's consent for a third party to access such data, whereas public domain data may be used without the consent of the data owner. Merely removing private or sensitive data, however, may not be sufficient to cause a model to “forget” such data, and a malicious attack may still reveal private information. Thus, regulatory compliance creates the need for technological solutions that allow a model owner or user not only remove sensitive data from a machine learning training dataset but also ensure that the influence of the sensitive data on a previously trained model is also eliminated.

### SUMMARY

In one or more embodiments, a method of providing automated guidance for machine unlearning includes executing, by a computer processor, an unlearning algorithm to expunge the influence of a selected sample on a machine learning model. The selected sample is a sample of a training dataset used to train the machine learning model. Executing the unlearning algorithm creates the unlearned model. The method includes generating, by a metrics generator implemented by the computer processor, performance metrics corresponding to the unlearned model and the machine learning model. The method includes generating, by a comparator implemented by the computer processor, based on the performance metrics, an unlearning analysis comparing performance of the unlearned model relative to performance of the machine learning model. The method includes generating, by a recommender, a recommendation based on the unlearning analysis. The recommendation recommends a revision to the unlearned model in response to detecting a deviation of more than a predetermined threshold of one or more of the performance metrics of the unlearned model from one or more of the performance metrics of the machine learning model. The method includes generating, by an evaluator implemented by the computer processor, an unlearning evaluation of the unlearned model.

In one or more embodiments, a system includes one or more processors configured to execute operations as described within this disclosure.

In one or more embodiments, a computer program product includes one or more computer-readable storage media and program instructions collectively stored on the one or more computer-readable storage media. The program instructions are executable by a processor to cause the processor to execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example architecture of an automated machine unlearning guidance (AMUG) framework.

FIG. 2 illustrates an example method of operation of the AMUG framework of FIG. 1.

FIG. 3 illustrates operative aspects of certain embodiments of the AMUG framework of FIG. 1.

FIG. 4 illustrates operative aspects of certain embodiments of the AMUG framework of FIG. 1.

FIG. 5 illustrates operative aspects of certain embodiments of the AMUG framework of FIG. 1.

FIG. 6 illustrates operative aspects of certain embodiments of the AMUG framework of FIG. 1.

FIGS. 7A and 7B are example outputs of recommendations and evaluations generated in accordance with certain embodiments by the AMUG framework of FIGS. 1 and 2.

FIG. 8 illustrates an example of a computing environment that is capable of implementing the AMUG framework of FIGS. 1 and 2.

### DETAILED DESCRIPTION

While the disclosure concludes with claims defining novel features, it is believed that the various features described within this disclosure will be better understood from consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to machine learning and, more particularly, to expunging selected data used to train a machine learning model and eliminating the influence of expunged data on predictions generated by the model. In accordance with the inventive arrangements described within this disclosure, methods, systems, and computer program products are provided that are capable generating analyses indicating the effects of machine unlearning on a machine learning model, the unlearning intended to expunge the influence of one or more samples in a training dataset used to train the machine learning model. The inventive arrangements generate, based on the automatically generated analyses, recommendations to improve performance of an unlearned model that is generated by executing an unlearning algorithm on the machine learning model. A rigorous evaluation of the unlearned model is generated by the inventive arrangements. A uniquely designed adversarial attack algorithm of the inventive arrangements generates an evaluation of the extent to which the unlearning has expunged the influence of the one or more samples on the unlearned model.

In certain embodiments, the inventive arrangements include executing, by a computer processor, an unlearning algorithm to expunge the influence of a selected sample on a machine learning model, the selected sample from a training dataset originally used to train the machine learning model. Executing the unlearning algorithm creates an unlearned model. A metrics generator implemented by the computer processor generates performance metrics corresponding to both the unlearned model and the machine learning model. As used herein, “performance” means how well the models operate as intended. Performance thus may refer to the models' predictive accuracy, mitigation of privacy risk, fairness of predictions generated, and/or performance measured along other dimensions. Based on the performance metrics, a comparator implemented by the computer processor generates an unlearning analysis comparing performance of the unlearned model relative to performance of the machine learning model. A recommender implemented by the computer processor, based on the unlearning analysis, generates a recommendation recommending a revision to the unlearned model in response to detecting a deviation of more than a predetermined threshold of one or more of the performance metrics corresponding to the unlearned model from one or more of the performance metrics of the machine learning model. An evaluator implemented by the computer processor generates an unlearning evaluation that evaluates the extent to which influence of the selected sample on the unlearned model is mitigated.

Machine unlearning is a technological solution to the problem of removing the influence of certain data from a previously trained machine learning model. Machine unlearning provides a computationally more efficient solution, with respect to both computational resources and time, over re-training the machine learning model from the ground up using a newly created dataset from which selected samples have been extracted.

Among the technological improvements of the inventive arrangements over current technologies is a reduction of both the time and computing resources (e.g., processors, memory) needed to eliminate the influence of sensitive information on a machine learning model, while simultaneously maintaining model performance along multiple other dimensions. Unlearning is an objective that often competes with other, possibly conflicting, objectives of the machine learning model such as predictive accuracy, privacy protection, and fairness. For example, unlearning may lessen the predictive accuracy of the model. Attempting to balance the competing objectives manually, even by an expert, is likely an ad hoc, trial-and-error process requiring extensive allocations of time and computing resources to configure and re-configure the machine learning model in an attempt to generate an unlearned model that meets multiple objectives. The inventive arrangements provide a systematic framework that reduces reliance on trial and error, thus reducing computing resource usage and enhancing the speed unlearning. Enhancing computational efficiency of the unlearning process relieves computing resources, making the resources available for other processing tasks.

Operatively, the enhanced computational efficiency and speed of unlearning provided by the inventive arrangements stems, in part, from their generating performance metrics along multiple dimensions during model unlearning, and based on rigorous evaluation of the metrics, generating one or more recommendations, optionally in real time. The framework enables model unlearning without re-training the model from scratch, while simultaneously maintaining the model's performance along other dimensions.

In one aspect, rigorous evaluation of certain metrics coupled with recommendations for effectively eliminating the influence of selected samples ensures that the unlearning is not illusory, thus reducing the likelihood of repetitive, ineffectual re-training that requires additional time and computing resource usage. Likewise, an aspect of rigorous evaluation of other metrics coupled with additional recommendations provides systematic guidance for effecting an unlearned model whose performance along other dimensions (e.g., predictive accuracy, privacy protection, fairness) likewise satisfies one or more predetermined standards.

In another aspect, the automated and rigorous evaluation of certain metrics provides a greater degree of confidence that the influence of one or more selected samples on the unlearned model is sufficiently eliminated. That is, the inventive arrangements confirm that the unlearned model is forgetting what it is supposed to forget. In still another aspect, the recommendations generated by the inventive arrangements enhance and maintain the performance and trustworthiness of the unlearned model.

The procedures and processes of the inventive arrangements, in certain embodiments, are performed iteratively. The unlearned model is executed iteratively on a modified dataset generated by removing the selected sample from the training dataset. With each iterative execution, a new recommendation is generated based on newly generated performance metrics. Based on each new recommendation, the unlearned model is revised until each of the performance metrics corresponding to the unlearned model satisfies a predetermined threshold criterion. A technical advantage is that with each iteration needed to refine the model, the recommendation supplies insight as to which parameter, hyperparameter, and/or other model aspect should be adjusted, and how it should be adjusted. This conserves the usage of hardware-related computing resources by avoiding ad hoc trial-and-error refinement of the model, which facilitates an informed balancing of the competing objectives of unlearning, accuracy, privacy, fairness, and/or other performance metrics.

In certain embodiments, performance metrics are generated for one or more additional unlearned models created by executing one or more other unlearning algorithms designed to expunge the influence on the machine learning model of selected samples of the training dataset. Unlearning analyses are generated for each of the additional unlearned models based on comparisons of performance metrics corresponding to each of the additional unlearned models with those corresponding to the machine learning model. Based on the comparisons, a comparative unlearning evaluation is generated. The comparative unlearning evaluation compares the performance of each additional unlearned model relative to the other unlearned models. A technical advantage is that multiple models are generated in conjunction, or nearly so, with one another, thereby permitting a readily available tool to evaluate the relative merits of each.

The performance metrics, in accordance with some embodiments, include an unlearning metric that measures mitigation of the influence of the selected sample from the training dataset on the unlearned model. The unlearning metric may be generated through an adversarial attack on the unlearned model. A uniquely designed adversarial attack, in accordance with some embodiments, is performed by searching a neighborhood of the training dataset around the selected sample. A test sample is generated by applying a norm-bound perturbation to each non-private feature of the selected sample with a norm-bound perturbation, leaving unperturbed each private feature of the selected sample unperturbed. The adversarial attack is executed on the unlearned model on the test sample to determine the predictive accuracy of the unlearned model. The less accurate the prediction, the greater the mitigation of influence of the selected sample on the unlearned model.

In other embodiments, the unlearning metric is generated by computing the JS-divergence between predictions generated by the modified machine learning model and the machine learning model. The unlearning metric in still other embodiments, is generated by computing a zero retrain forgetting (ZRF) score.

In various embodiments, performance metrics provide a predetermined measure of prediction accuracy of the unlearned model, mitigation of privacy risk by the unlearned model, and fairness of predictions generated by the unlearned model.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

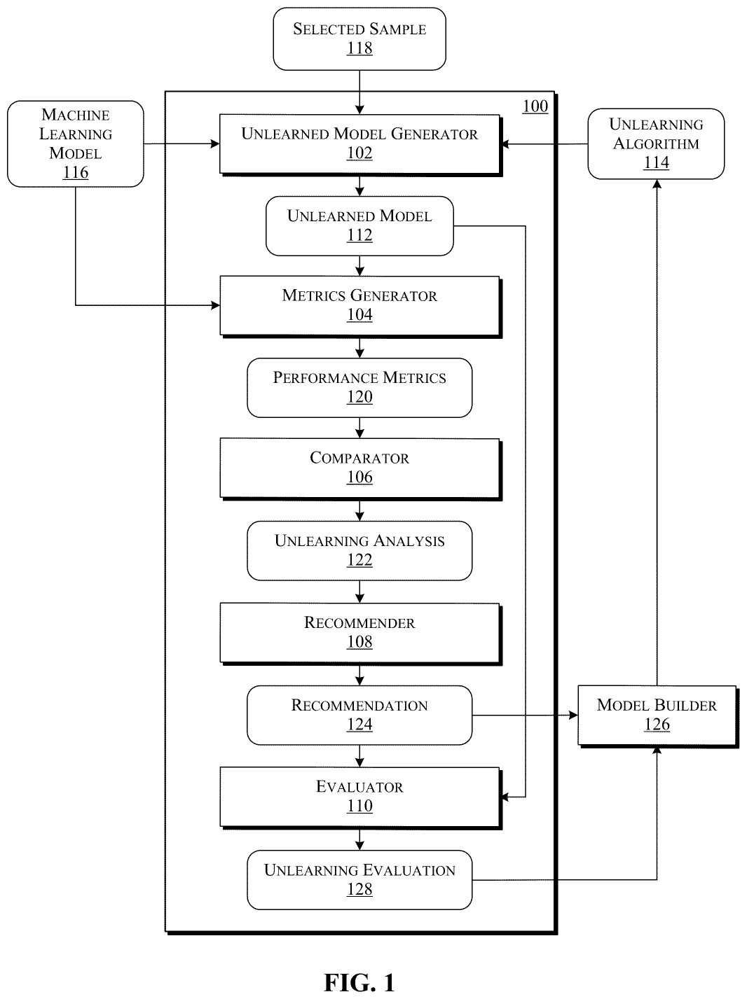

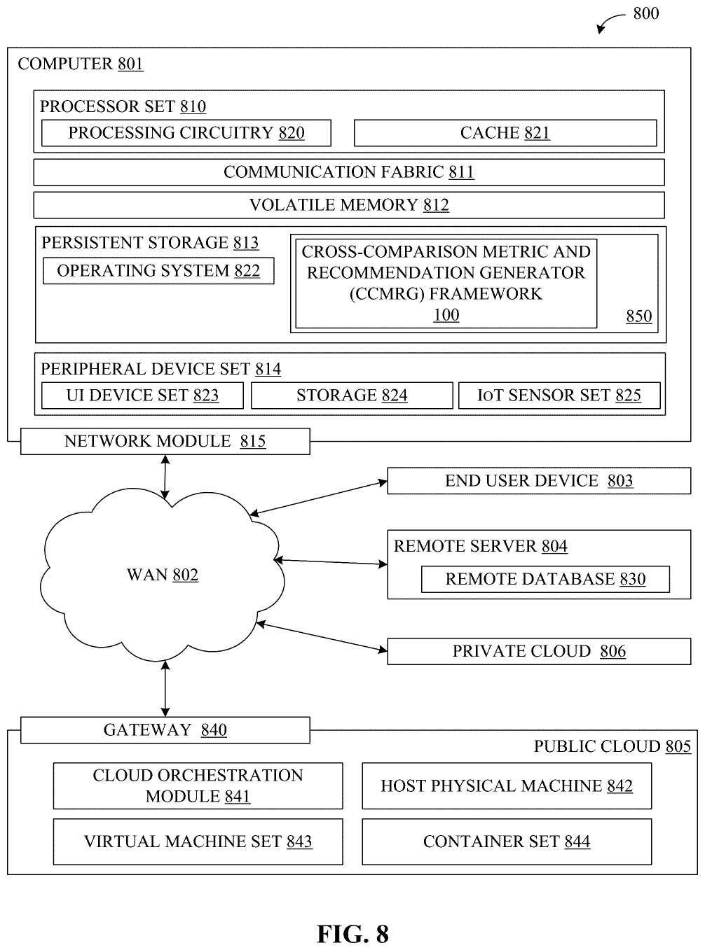

FIG. 1 illustrates an example architecture for an executable automated machine unlearning guidance (AMUG) framework 100. AMUG framework 100 provides machine unlearning guidance, which in various aspects includes generating cross-comparison metrics and particularized recommendations for improving machine unlearning of a previously trained machine learning model. The recommendations generated by AMUG framework 100 facilitate generation of unlearned model 112, as described below. In the example architecture of FIG. 1, AMUG framework 100 illustratively includes unlearned model generator 102, metrics generator 104, comparator 106, recommender 108, and evaluator 110. AMUG framework 100, in certain embodiments, may be implemented in software that is executable on the hardware of a computer such as computer 801 operating in computing environment 800, as described in reference to FIG. 8.

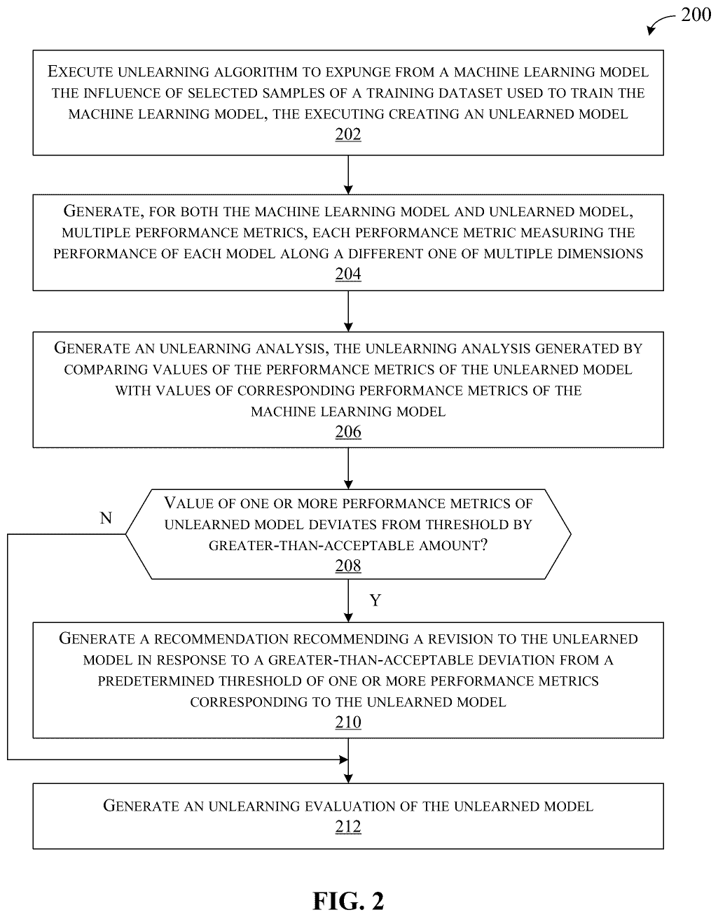

FIG. 2 illustrates an example method 200 of operation of AMUG framework 100 of FIG. 1. Referring to FIGS. 1 and 2 collectively, in block 202, unlearned model generator 102 generates unlearned model 112. Unlearned model 112 is created by executing on a computer processor unlearning algorithm 114 as applied to previously trained machine learning model 116. Unlearning algorithm 114 is designed to expunge the influence of selected sample 118 on machine learning model 116. Selected sample 118 is part of the training dataset that was used to train machine learning model 116 and may comprise data that contains one or more sensitive or private features. Simply removing selected sample 118 from the training dataset may not eliminate its influence on predictions (e.g., classifications, regressions) generated by machine learning model 116. Moreover, it may be costly to retrain machine learning model 116 with a new training dataset from which selected sample 118 is removed. Unlearning algorithm 114 is designed to generate unlearned model 112, from which the influence of selected sample 118 is removed or reduced to an acceptable extent.

Unlearning algorithm 114 may be implemented in a software program input to AMUG framework 100 by a user via a user interface (e.g., a Graphical User Interface or “GUI”). In some embodiments, unlearning algorithm 114 is automatically selected by AMUG framework 100 from a database that electronically stores a collection of software implementing one or more unlearning algorithms. Unlearning algorithm 114 may be a heretofore unknown unlearning algorithm or may be any one of various known unlearning algorithms. Existing unlearning algorithms may include, for example, the Sharded, Isolated, Sliced, and Aggregated (SISA) unlearning algorithm, the No-Regret Shrinking (NRS) unlearning algorithm, and the algorithm for Unlearning Machine learning models with Rigorous Regularization and Adaptive learning rates (UMRRA), as well as other known unlearning algorithms.

In block 204, metrics generator 104 generates performance metrics 120 corresponding to both unlearned model 112 and machine learning model 116. Metrics generator 104 is capable of generating various types of metrics for measuring the performance of both unlearned model 112 and of machine learning model 116 along various dimensions. Performance metrics 120, for example, may measure the predictive accuracy of both unlearned model 112 and machine learning model 116. Performance metrics 120 may measure, for example, the risk posed to an individual's privacy by applying unlearned model 112 and machine learning model 116 to the individual's personal information, vocal rendering, and/or image. Performance metrics 120 may measure the fairness of predictions (e.g., classifications) generated by both unlearned model 112 and machine learning model 116. In various other embodiments, other measures of performance and trustworthiness of unlearned model 112 and machine learning model 116 may be measured by different types of performance metrics.

Performance metrics 120 are generated by metrics generator 104's executing both unlearned model 112 and machine learning model 116 on a test dataset. In certain arrangements, values of the respective performance metrics 120 of the unlearned model 112 and machine learning model 116 are generated by executing both models on the same test dataset. The test dataset may exclude selected sample 118. The test dataset, in some arrangements, includes samples from the training dataset, other than selected sample 118, previously used to train machine learning model 116, and a membership inference risk of unlearned model 112 is determined by executing the model on the test dataset. In other arrangements, for specifically testing the effectiveness of the unlearning by unlearned model 112, the test dataset may comprise only selected sample 118. The greater the unlearning, the less is the predictive accuracy of unlearned model 112 with respect to selected sample 118. That is, unlearned model 112 is less likely to correctly classify, or other otherwise generate a correct prediction, based on selected sample 118. In certain embodiments, the test dataset comprises a test sample, which is generated by perturbing selected sample 118. The perturbed test sample may be used in an adversarial attack against unlearned model 112 to determine the effectiveness of the model's unlearning.

Performance metrics 120 are generated by separately executing various inferential procedures on both unlearned model 112 and machine learning model 116, as described in more detail below. In various embodiments, metrics generator 104 executes unlearning model 112 and machine learning model 116 on whichever type of data is necessary given the specific technique used to generate a specific performance metric.

A performance metric generated by metrics generator 104 to measure predictive accuracy, for example, may be the percentage of correct predictions (e.g., classifications, regressions, clusters) generated by both unlearned model 112 and machine learning model 116. To make the performance metrics for accuracy comparable, both unlearned model 112 and machine learning model 116 generate predictions based on the same test dataset.

In generating performance metrics to measure privacy risk, for example, metrics generator 104, in some embodiments, measures the risk according to the Probably Approximately Correct (PAC) Privacy metric, which is generated with an algorithm that determines the minimal amount of randomness that must be injected into unlearned model 112 and machine learning model 116 to protect private data from an adversarial attack. In other embodiments, metrics generator 104 generates performance metrics measuring privacy risk using the ML Privacy Meter, an open-source library that implements inferential methods that quantify privacy risks associated with various machine learning and statistical models. In some embodiments, metrics generator 104 measures privacy risk using the SHAPr membership privacy risk metric, which is determined using a “leave-one-out” approach. In still other embodiments, metrics generator 104 generates performance metrics measuring privacy risk by subjecting unlearned model 112 and machine learning model 116 to a model inversion attack to determine whether the attack successfully reveals selected sample 118. These are only examples. In various other embodiments, metrics generator 104 generates metrics measuring privacy risk using various other techniques.

Performance metrics 120, in certain embodiments, also include metrics measuring fairness, for example. As with performance metrics 120 pertaining to privacy, metrics generator 104 is capable of generating fairness-related metrics by implementing any of various techniques. In some embodiments, with respect to both unlearned model 112 and machine learning model 116, metrics generator 104 generates a Statistical Parity Difference (SPD), which measures the difference between the portion of favorable predictions the respective models generate for a group suspected of unfair treatment and favorable predictions corresponding to other groups. In some embodiments, metrics generator 104 generates with respect to both unlearned model 112 and machine learning model 116, the Equal Opportunity Difference (EOD) fairness metric, which similarly measures the difference between true positive rates (TPR) for separate groups. Beyond these examples, metrics generator 104, in other embodiments, is capable of implementing various other techniques for generating performance metrics 120 that measure the fairness of predictions generated by both unlearned model 112 and machine learning model 116.

In block 206, comparator 106 generates unlearning analysis 122. Unlearning analysis 122, in certain embodiments, is generated by comparator 106's comparing the values of each performance metric of unlearned model 112 with values of each corresponding performance metric of machine learning model 116. The comparisons generated by comparator 106 are based on performance metrics 120, which measure along the various dimensions (e.g., accuracy, privacy risk, fairness) of how well unlearned model 112 performs with respect to machine learning model 116. In some embodiments, if model 112 performs relatively less well than machine learning model 116, then unlearning analysis 122, as generated by comparator 106, identifies the likely dimension or dimensions (e.g., accuracy, privacy risk, fairness) along which unlearned model 112's performance is deficient. In certain embodiments, a set of thresholds can be input (e.g., via a GUI) to comparator 106 such that comparator 106 determines the extent or degree to which one or more performance aspects of unlearned model 112 fail to meet a given threshold.

In certain arrangements, a predetermined threshold is comparative in the sense that the threshold sets a limit on the extent to which an aspect of unlearned model 112's performance may acceptably deviate from that of machine learning model 116. The deviation is measured by a difference between the respective values of the same performance metric for both unlearned model 112 and machine learning model 116. The threshold may specify how large a difference in values of the same performance metric for both unlearned model 112 and machine learning model 116 may be and still be acceptable. This facilitates a direct comparison between the performance of unlearned model 112 and that of machine learning model 116. An implicit assumption is that machine learning model 116 previously trained on a dataset that includes selected sample 118 performs adequately, and the question is how unlearning the influence selected sample 118 by unlearned model 112 affects performance along various dimensions.

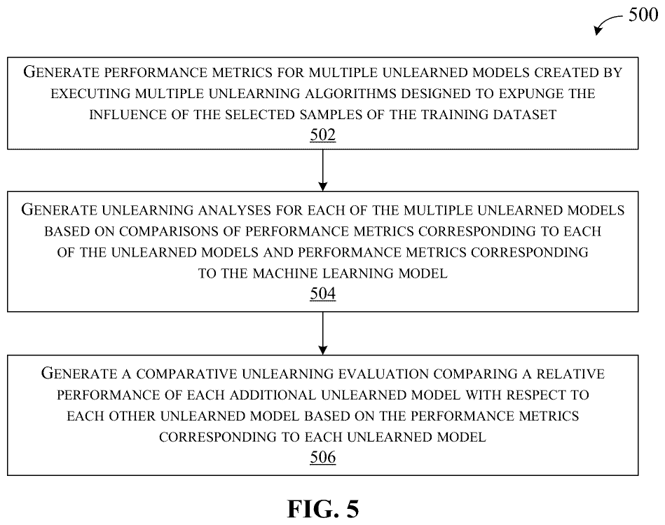

In other arrangements, a threshold establishes an independent benchmark for an aspect of unlearned model 112's performance. For example, a user-supplied threshold for the performance metric measuring unlearned model 112's predictive accuracy may set a minimum value of eighty-five (85) percent. Thus, an acceptable deviation from perfect predictive accuracy is no more than fifteen (15) percent. A threshold for measuring the effectiveness of unlearned model 112's unlearning in eliminating the influence of selected sample 118 on the model may be set, for example, by a regulator or legislative dictate. The threshold, for example, may set a maximum value of ten (10) percent for the likelihood of a correct prediction when unlearned model 112 is run on selected sample 118. Accordingly, any deviation from zero percent accuracy by more than ten (10) percent is unacceptable. Thresholds that establish independent benchmarks for performance of unlearned model 112 facilitate the comparison of unlearned model 112's performance with that of one or more other unlearned models that may substitute for machine learning model 116. Comparisons for selecting among multiple alternative unlearned models are described in greater detail with reference to FIGS. 5, 6, 7A, and 7B.

More generally, in various embodiments, unlearning analysis 122, as generated by comparator 106, quantifies unlearned model 112's performance individually, in relation to machine learning model 116's performance, and/or in relation to multiple other unlearned models.

In block 208, if one or more of performance metrics 120 deviate from a predetermined threshold, comparator 106 automatically invokes processes performed by recommender 108.

In block 210, based on unlearning analysis 122, recommender 108 generates recommendation 124. Recommendation 124 recommends an action to improve unlearned model 112's performance with respect to any greater-than-acceptable deviations from a predetermined threshold. In certain embodiments, based on unlearning analysis 122, recommender 108 generates a recommendation recommending a revision to the unlearned model in response to detecting a deviation of more than a predetermined threshold of one or more of the performance metrics corresponding to unlearned model 112 from one or more of the performance metrics of machine learning model 116.

The action may modify unlearning algorithm 114, and AMUG framework 100 may initiate re-running the now-modified unlearning algorithm on machine learning model 116. Executing the algorithm, now modified according to recommendation 124, regenerates unlearned model 112 to improve the performance of unlearned model 112 with respect to one or more of performance metrics 120. Recommendation 124 may depend on machine learning model 116's type (e.g., random forest, convolutional neural network, recurrent neural network) and each performance deficiency of unlearned model 112, as well as other factors such as the type of data used to train machine learning model 116. For example, if machine learning model 116 is a convolutional neural network (CNN) trained on images and unlearned model 112's predictive accuracy in classifying images is below a predetermined threshold, then recommendation 124 may recommend widening the existing CNN layers or deepening the overall network. If machine learning model 116 is a pretrained language model that poses an unacceptable privacy risk, for example, recommendation 124 may recommend changing one or more hyperparameters (e.g., learning rate, clipping bound) and fine tuning the model using differentially private stochastic gradient descent (DP-SGD). In some situations, depending on the nature of unlearning analysis 122 and any performance deficiency, recommendation 124 may recommend replacing unlearned model 112 with a different one generated using an unlearning algorithm different from unlearning algorithm 114.

More generally, recommender 108 in certain embodiments identifies a deficiency of unlearned model 112—the deficiency identified by the comparison of the unlearned model 112's performance metrics with those of machine learning model 116—and correlates the identified deficiency with recommendation 124, a specific recommendation likely to ameliorate the deficiency. Recommender 108, for example, may recommend adding, eliminating, or adjusting a parameter and/or hyperparameter of unlearned model 112. Recommender 108, for example, may recommend one or more successive iterations of execution of unlearning algorithm 114 on the machine learning model 116 or may recommend replacing unlearning algorithm 114 with an alternative algorithm. Recommender 108 may correlate each identified deficiency of unlearned model 112 with an appropriate recommendation based on a classification of the deficiency identified. For example, in certain embodiments, recommender 108 may implement a machine learning classification model that classifies the identified deficiency and generates a recommendation that is selected from multiple alternative ones depending on the classification of the identified deficiency of unlearned model 112. In other embodiments, recommender 108 correlates each identified deficiency of unlearned model 112 with an appropriate recommendation using a static lookup table that maps values of performance metrics 120 to the recommendations.

Recommender 108, in certain embodiments, conveys recommendation 124 to model builder 126. In an embodiment, model builder 126 may be a user who, based on recommendation 124, revises unlearned algorithm 114 according to recommendation 124 and re-runs the algorithm (on machine learning model 116) to improve unlearned model 112's performance in accordance with recommendation 124. In certain embodiments, model builder 126 may be implemented in hardware, software, or a combination thereof, and recommendation 124 may be a signal or executable code for automatically modifying unlearning algorithm 114 and executing anew the modified algorithm to improve unlearned model 112's performance according to recommendation 124.

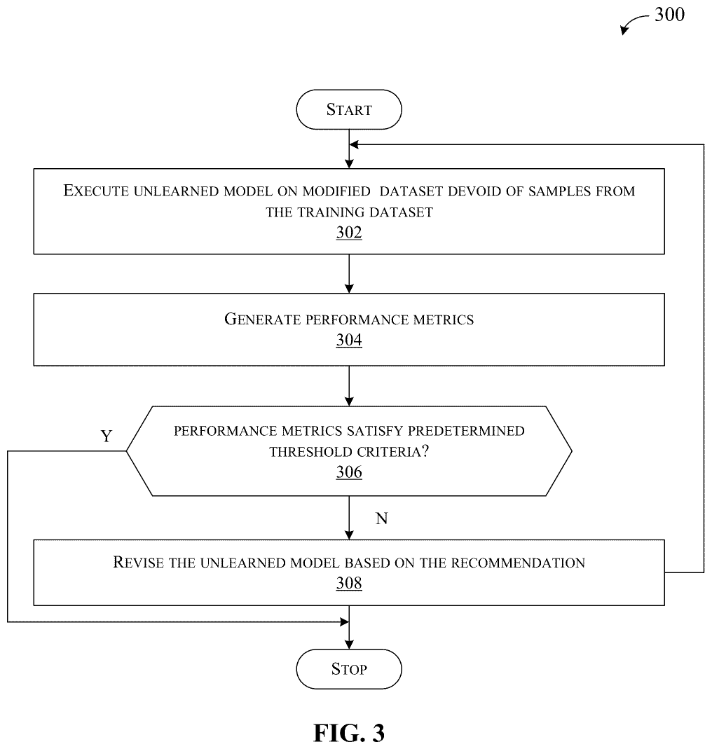

In certain embodiments, AMUG framework 100 repeats the described processes, iteratively executing unlearned model 112 on a modified dataset, which is generated by removing selected sample 118 from the training dataset used to train machine learning model 116. Referring additionally to FIG. 3, the iterative process is illustrated by method 300, which may be performed by AMUG framework 100. In block 302, AMUG framework 100 iteratively executes unlearned model 112 on a modified dataset from which selected sample 118 has been removed. In block 304, metrics generator 104 generates performance metrics as described above after each iterative execution. If after an iterative execution, comparator 106 determines in block 306 that one or more performance metrics fails to satisfy a predetermined threshold criterion, then recommender 108 generates a recommendation, which if performed by model builder 126, revises unlearned model 112 in block 308. Thus, unlearned model 112 may be iteratively revised until each of the performance metrics corresponding to unlearned model 112 satisfies a predetermined set of threshold criteria. The threshold criteria can be established by a model owner (e.g., enterprise), a regulator, or a data owner who has objected to the use of owned data, such as personal information, vocal rendering, image(s), or other type of private or sensitive information.

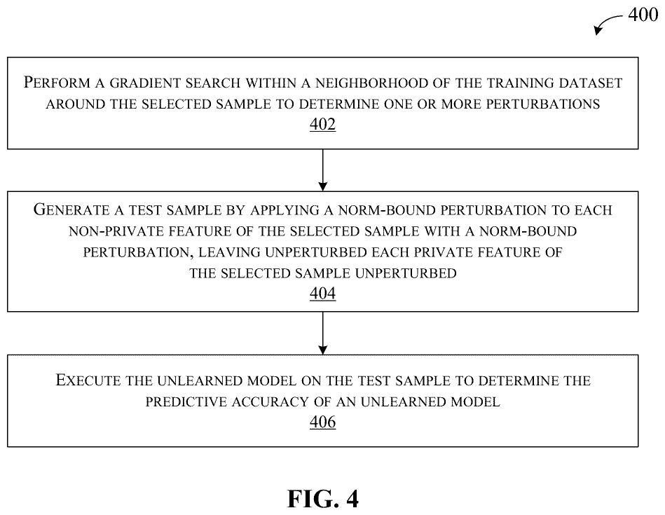

Referring still to FIGS. 1 and 2, in block 212, evaluator 110 generates unlearning evaluation 128. Unlearning evaluation 128 provides a measure of the influence that remains of selected sample 118 on predictions generated by unlearned model 112. In certain embodiments, the influence remaining is measured by subjecting unlearned model 112 to the adversarial attack described below with reference to FIG. 4. In other embodiments, the influence that remains is measured by membership inference risk. In still other embodiments, the influence is measured by the Jensen-Shannon (JS) divergence between predictions generated by unlearned model 112 and machine learning model 116.

FIG. 4 illustrates an example method 400 for determining the remaining influence of selected sample 118 on predictions generated by unlearned model 112. Method 400 implements an adversarial attack on unlearned model 112 and, in accordance with certain embodiments, is performed by evaluator 110 of AMUG framework 100.

In block 402, evaluator 110 searches a neighborhood of the training dataset around selected sample 118, the training dataset being the one used to train machine learning model 116. In certain embodiments, evaluator 110 performs the search of the neighborhood of selected sample 118 by implementing a gradient search. The samples of the training dataset, including selected sample 118, are feature vectors. The gradient search determines a direction within the neighborhood to perturb certain features of the vectors (e.g., add a value E to the value of a feature). Performing the gradient search within a neighborhood of the training dataset around selected sample 118 determines one or more perturbations that optimize a loss function of the unlearned model for testing model accuracy with respect to unlearned data. Perturbation of a feature thus decreases unlearned model 112's loss function and increases the model's accuracy with respect to data that is to be unlearned and whose influence is to be mitigated or eliminated entirely. Thus, in an embodiment, the gradient search implemented by evaluator 110 optimizes the loss function of unearned model 112, where optimizing includes minimizing the loss function and maximizing the predictive accuracy of unlearned model 112.

In block 404, evaluator 110 generates a test sample by perturbing one or more non-private features of selected sample 118, leaving each private feature of the selected sample unperturbed. The perturbation of a feature is a norm-bound perturbation. That is, the maximum extent of each perturbation to a non-sensitive feature is constrained by a predetermined amount, the norm bound. By constraining the extent of each perturbation, the predetermined norm bound ensures that the perturbed sample is sufficiently close in the sense of a distance metric (e.g., absolute distance, squared or Euclidean distance) to the corresponding unperturbed sample. Sufficient closeness to the unperturbed sample mitigates the likelihood that the perturbed sample destroys the information that the unperturbed sample contributes to the unlearned model, thus enhancing the unlearned model's robustness. The value of the norm bound can be determined empirically. In some embodiments, for example, a grid search is performed over a range of values, and the value that yields the best model predictions on a validation set is selected as the optimal value of the norm bound. In other embodiments, a value for the norm bound is determined based on a priori knowledge of the model data (e.g., text, image, voice) and/or the model architecture.

In block 406, unlearned model 112 is executed on the test sample to determine the predictive accuracy of unlearned model 112. The predictive accuracy in certain embodiments is measured as a percentage of correct classifications or other predictions generated by unlearned model 112 when the model runs on the test sample. The percentage of correct predictions is correlated with the extent to which unlearned model “forgets” and is not influenced by selected sample 118. The lower the percentage of correct predictions the greater the degree to which the influence of selected sample 118 has been reduced by unlearning algorithm 114.

In certain embodiments, evaluator 110 of AMUG framework 100 generates a comparative unlearning evaluation. The comparative unlearning evaluation compares the performance of multiple unlearned models relative to one another. The unlearned models are generated by the execution of different unlearning algorithms on the same test dataset. The comparative unlearning evaluation of multiple unlearned models relative to one another provides a model owner with the option of choosing one of the multiple unlearned models depending on which performance criteria are most important to the model owner.

FIG. 5 illustrates an example method 500 for generating a comparative unlearning evaluation. Method 500, in accordance with certain embodiments, is performed by AMUG framework 100. Illustratively, in block 502, metrics generator 104 of AMUG framework 100 generates performance metrics for multiple unlearned models created by executing multiple unlearning algorithms designed to expunge the influence of selected sample 118 on each of the multiple unlearned models. In block 504, comparator 106 generates unlearning analyses for each of the multiple unlearned models based on comparisons of performance metrics corresponding to each of the unlearned models and performance metrics corresponding to machine learning model 116. In block 506, evaluator 110 generates the comparative unlearning evaluation comparing a relative performance of each of the multiple unlearned models with respect to each other based on the performance metrics corresponding to each unlearned model.

Thus, according to such embodiments with respect to FIGS. 1 and 2, in addition to performance metrics 120 for unlearned model 112, metrics generator 104 of AMUG framework 100 generates additional performance metrics for one or additional unlearned models. Comparator 106 generates unlearning analyses for each additional unlearned model, as well as unlearning analysis 122 for unlearned model 112. The comparative unlearning evaluation generated by evaluator 110 compares the performance of unlearned model 112 with each additional unlearned model based on performance metrics corresponding to unlearned model 112 and the additional performance metrics corresponding to each additional unlearned model.

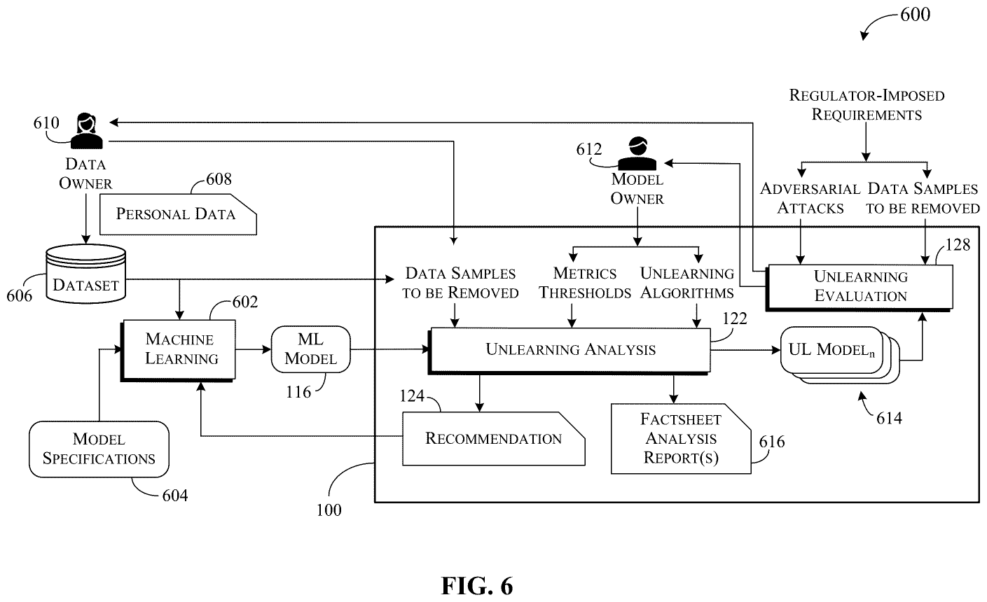

FIG. 6 provides a schematic overview 600 illustrating aspects of certain embodiments of AMUG framework 500. Machine learning model 116 is generated by execution of machine learning 602, an algorithm that trains machine learning model 116 according to model specifications 604 using dataset 606 as a training dataset. Dataset 606 includes personal data 608 owned by data owner 610. Illustratively, personal data 608 includes one or more personal or sensitive samples. Data owner 610 requests that the sample be expunged and that machine learning model 116 forget the samples. To comply with data owner 610's request, model owner 612 inputs machine learning model 116 to AMUG framework 100, which processes machine learning model 116 using multiple unlearning algorithms to generate unlearned models 614 (n distinct unlearned (UL) models). Executing the processes and procedures described above, AMUG framework 100 generates for each of unlearned models 614 unlearning analysis 122. If unlearning analysis 122 identifies an unlearned model for which one or more corresponding performance metrics 120 fails to satisfy a predetermined threshold, then recommender 108 generates recommendation 124 to improve the unlearned model's performance. AMUG framework 100 generates unlearning evaluation 128 for each of unlearned models 614 and may generate a comparative unlearning analysis, which contrasts each unlearned model's performance metrics with those of the other unlearned models.

Unlearning evaluation 128 provides a measure of how effective an unlearning algorithm has been in eliminating the influence of selected sample 118 with respect to each of the set of unlearning models 614. The determination may be made by subjecting each of unlearning models 614 to adversarial attacks, such as that described with reference to FIG. 4. The determination can reveal which, if any, of the set of unlearning models 614 meet requirements imposed by certain regulatory requirements regarding privacy, for example. Unlearning evaluation 128 may be provided to model owner 612 and/or a regulator. In certain embodiments, the regulator may communicatively couple with evaluator 110 of AMUG framework 100 over a data communication network (e.g., Internet). Accessing evaluator 110, the regulator may directly test the degree to which each unlearned model has forgotten the samples to be removed by, for example, subjecting the unlearned model to an adversarial attack such as that described with reference to FIG. 4.

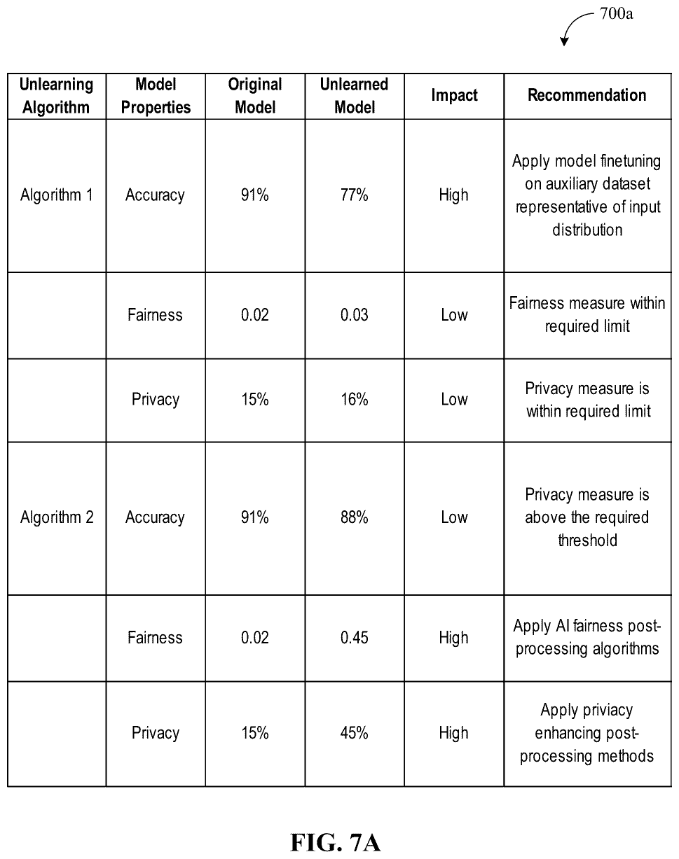

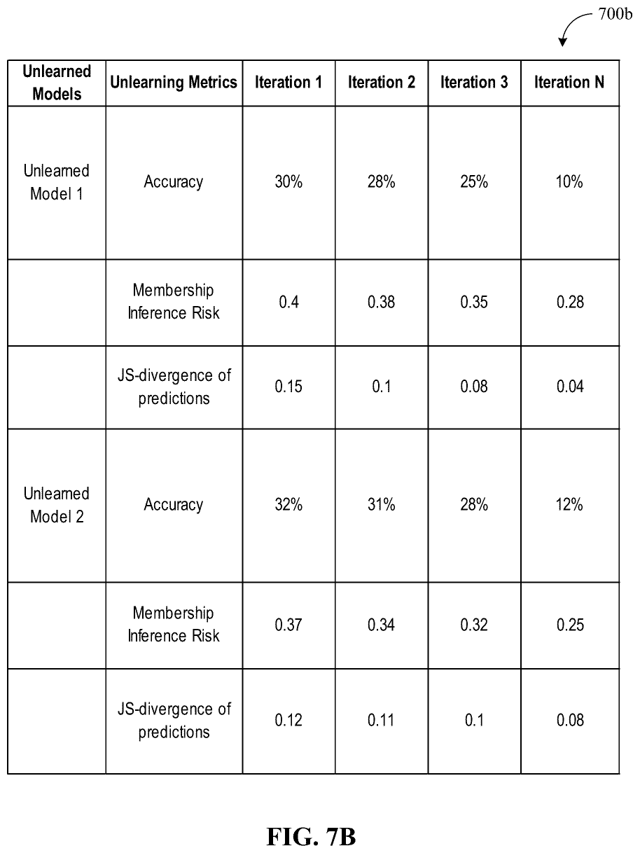

In certain embodiments, AMUG framework 100 outputs one or more analysis reports 616 for each of unlearned models 614. FIG. 7A illustrates an analysis report in the form of factsheet 700a including recommendations generated by AMUG framework 100. The first column of 700a identifies unlearned algorithms applied with respect to machine learning model 116. The second column lists separate model properties (accuracy, fairness, and privacy) of both the unlearned models generated by each unlearning algorithm and machine learning model 116. The third and fourth columns, respectively list performance metrics 120 that correspond to each property for both a machine learning model and unlearned model 116. The fifth column lists impacts with respect to each property that the unlearning algorithms had on each unlearned model relative to machine learning model 116, the impacts based on comparison of performance metrics 120 corresponding to each unlearned model relative to machine learning model 116.

FIG. 7B illustrates output of unlearning evaluations 700b generated by AMUG framework 100. The evaluations indicate the extent to which the influence of selected sample 118 has been reduced by each unlearned model after successive iterations applying the corresponding unlearned algorithm to machine learning model 116. As shown, three different measures are used to evaluate the extent of unlearning. The first measure is that which is determined by application of the adversarial attack of method 400 described in the context of FIG. 4.

The second measure is a Zero Retrain Forgetting (ZRF) score. The ZRF score is a model-free evaluation metric of the underlying unlearning method implemented with each unlearning algorithm used to induce forgetting of selected sample 118. The third measure is the Jensen Shannon (JS) divergence between predictions generated by each unlearned model and machine learning model 116. JS divergence measures the amount of information lost by applying an unlearning algorithm to machine learning model 116.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 8, computing environment 800 contains an example of an environment for the execution of at least some of the computer code in block 850 involved in performing the inventive methods, such as AMUG framework 100 implemented as executable program code or instructions. AMUG framework 100 generates analyses indicating the effects of machine unlearning on a machine learning model. Based on the analyses, AMUG framework 100 generates recommendations to improve performance of an unlearned model generated by executing an unlearning algorithm on the machine learning model. A rigorous evaluation of the unlearned model is generated by AMUG framework 100, which also, in certain embodiments, executes a uniquely designed adversarial attack algorithm to evaluate the extent to which the unlearning has expunged the influence on the unlearned model of one or more samples originally used to train the machine learning model.

Computing environment 800 additionally includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and AMUG framework 100, as identified above), peripheral device set 814 (including user interface (UI) device set 823, storage 824, and Internet of Things (IoT) sensor set 825), and network module 815. Remote server 804 includes remote database 830. Public cloud 805 includes gateway 806, cloud orchestration module 841, host physical machine set 842, virtual machine set 843, and container set 844.

Computer 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

Processor set 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

Communication fabric 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

Persistent storage 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid-state storage devices. Operating system 822 may take several forms, such as various known proprietary operating systems or open-source Portable Operating System Interface type operating systems that employ a kernel. The code included in block 850 typically includes at least some of the computer code involved in performing the inventive methods.

Peripheral device set 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (e.g., where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

Network module 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (e.g., embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 803 is any computer system that is used and controlled by an end user (e.g., a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

Remote server 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

Public cloud 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The terminology used herein is for the purpose of describing particular embodiments only and is not intended to be limiting. Notwithstanding, several definitions that apply throughout this document now will be presented.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms “first,” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
executing, by a computer processor, an unlearning algorithm to expunge influence on a machine learning model of a selected sample of a training dataset used to train the machine learning model, wherein the executing creates an unlearned model;
generating, by a metrics generator implemented by the computer processor, performance metrics corresponding to the unlearned model and the machine learning model;
generating, by a comparator implemented by the computer processor, based on the performance metrics, an unlearning analysis comparing performance of the unlearned model relative to performance of the machine learning model;
generating, by a recommender, a recommendation based on the unlearning analysis recommending a revision to the unlearned model in response to detecting a deviation of more than a predetermined threshold of one or more of the performance metrics corresponding to the unlearned model from one or more of the performance metrics of the machine learning model; and
generating, by an evaluator implemented by the computer processor, an unlearning evaluation of the unlearned model.

2. The computer-implemented method of claim 1, further comprising:
iteratively executing the unlearned model on a modified dataset generated by removing the selected sample from the training dataset;
with each iterative execution, generating a new recommendation based on newly generated performance metrics; and
following each iterative execution, based on the new recommendation, revising the unlearned model until each of the performance metrics corresponding to the unlearned model satisfies a predetermined threshold criterion.

3. The computer-implemented method of claim 1, further comprising:
generating additional performance metrics corresponding to one or more additional unlearned models created by executing one or more other unlearning algorithms designed to expunge influence on the machine learning model of the selected sample of the training dataset;
generating unlearning analyses for each of the one or more additional unlearned models based on comparisons of the additional performance metrics corresponding to each of the one or more additional unlearned models and the performance metrics corresponding to the machine learning model; and
generating a comparative unlearning evaluation comparing a relative performance of each additional unlearned model based on the additional performance metrics corresponding to each of the one or more additional unlearned models.

4. The computer-implemented method of claim 1, wherein the performance metrics include an unlearning metric measuring mitigation of influence of the selected sample on the unlearned model, and wherein generating the unlearning metric includes:
performing a gradient search within a neighborhood of the training dataset around the selected sample to determine one or more perturbations to optimize a loss function of the unlearned model for testing model accuracy with respect to unlearned data;
generating a test sample by applying a norm-bound perturbation to each non-private feature of the selected sample, leaving each private feature of the selected sample unperturbed; and
executing the unlearned model on the test sample to determine a predictive accuracy of the unlearned model.

5. The computer-implemented method of claim 1, wherein the performance metrics provide a predetermined measure of at least one of prediction accuracy, privacy risk, or fairness associated with the unlearned model and the machine learning model.

6. The computer-implemented method of claim 1, further comprising:
generating a JS-divergence between predictions generated by the unlearned model and the machine learning model, wherein the JS-divergence provides a performance metric measuring mitigation of influence of the selected sample on the unlearned model.

7. The computer-implemented method of claim 1, further comprising:
generating a zero retrain forgetting (ZRF) score for the unlearned model, wherein the ZRF score provides a performance metric measuring mitigation of influence of the selected sample on the unlearned model.

8. A system, comprising:
one or more processors configured to execute operations including:
executing an unlearning algorithm to expunge influence on a machine learning model of a selected sample of a training dataset used to train the machine learning model, wherein the executing creates an unlearned model;
generating, by a metrics generator, performance metrics corresponding to the unlearned model and the machine learning model;
generating, by a comparator, based on the performance metrics, an unlearning analysis comparing performance of the unlearned model relative to performance of the machine learning model;
generating, by a recommender, a recommendation based on the unlearning analysis recommending a revision to the unlearned model in response to detecting a deviation of more than a predetermined threshold of one or more of the performance metrics corresponding to the unlearned model from one or more of the performance metrics of the machine learning model; and
generating, by an evaluator, an unlearning evaluation of the unlearned model.

9. The system of claim 8, wherein the one or more processors are configured to execute operations further including:
iteratively executing the unlearned model on a modified dataset generated by removing the selected sample from the training dataset;
with each iterative execution, generating a new recommendation based on newly generated performance metrics; and
following each iterative execution, based on the new recommendation, revising the unlearned model until each of the performance metrics corresponding to the unlearned model satisfies a predetermined threshold criterion.

10. The system of claim 8, wherein the one or more processors are configured to execute operations further including:
generating additional performance metrics corresponding to one or more additional unlearned models created by executing one or more other unlearning algorithms designed to expunge influence on the machine learning model of the selected sample of the training dataset;
generating unlearning analyses for each of the one or more additional unlearned models based on comparisons of the additional performance metrics corresponding to each of the one or more additional unlearned models and the performance metrics corresponding to the machine learning model; and
generating a comparative unlearning evaluation comparing a relative performance of each additional unlearned model based on the additional performance metrics corresponding to each of the one or more additional unlearned models.

11. The system of claim 8, wherein the performance metrics include an unlearning metric measuring mitigation of the influence of the selected sample on the unlearned model, and wherein generating the unlearning metric includes:
performing a gradient search within a neighborhood of the training dataset around the selected sample to determine one or more perturbations to optimize a loss function of the unlearned model for testing model accuracy with respect to unlearned data;
generating a test sample by applying a norm-bound perturbation to each non-private feature of the selected sample with a norm-bound perturbation, leaving unperturbed each private feature of the selected sample unperturbed; and
executing the unlearned model on the test sample to determine a predictive accuracy of the unlearned model.

12. The system of claim 8, wherein the performance metrics provide a predetermined measure of at least one of prediction accuracy, privacy risk, and fairness associated with the unlearned model and the machine learning model.

13. The system of claim 8, wherein the one or more processors are configured to execute operations further including:
generating a JS-divergence between predictions generated by the unlearned model and the machine learning model, wherein the JS-divergence provides a performance metric measuring mitigation of influence of the selected sample on the unlearned model.

14. A computer program product, the computer program product comprising:
one or more computer-readable storage media and program instructions collectively stored on the one or more computer-readable storage media, the program instructions executable by a processor to cause the processor to execute operations including:
executing an unlearning algorithm to expunge influence on a machine learning model of a selected sample of a training dataset used to train the machine learning model, wherein the executing creates an unlearned model;
generating, by a metrics generator, performance metrics corresponding to the unlearned model and the machine learning model;
generating, by a comparator, based on the performance metrics, an unlearning analysis comparing performance of the unlearned model relative to performance of the machine learning model;
generating, by a recommender, a recommendation based on the unlearning analysis recommending a revision to the unlearned model in response to detecting a deviation of more than a predetermined threshold of one or more of the performance metrics corresponding to the unlearned model from one or more of the performance metrics of the machine learning model; and
generating, by an evaluator, an unlearning evaluation of the unlearned model.

15. The computer program product of claim 14, wherein the program instructions are executable by the processor to cause the processor to execute operations further including:
iteratively executing the unlearned model on a modified dataset generated by removing the selected sample from the training dataset;
with each iterative execution, generating a new recommendation based on newly generated performance metrics; and
following each iterative execution, based on the new recommendation, revising the unlearned model until each of the performance metrics corresponding to the unlearned model satisfies a predetermined threshold criterion.

16. The computer program product of claim 14, wherein the program instructions are executable by the processor to cause the processor to execute operations further including:
generating additional performance metrics corresponding to one or more additional unlearned models created by executing one or more other unlearning algorithms designed to expunge influence on the machine learning model of the selected sample of the training dataset;
generating unlearning analyses for each of the one or more additional unlearned models based on comparisons of the additional performance metrics corresponding to each of the one or more additional unlearned models and the performance metrics corresponding to the machine learning model; and
generating a comparative unlearning evaluation comparing a relative performance of each additional unlearned model based on the additional performance metrics corresponding to each of the one or more additional unlearned models.

17. The computer program product of claim 14, wherein the performance metrics include an unlearning metric measuring mitigation of the influence of the selected sample on the unlearned model, and wherein generating the unlearning metric includes:
performing a gradient search within a neighborhood of the training dataset around the selected sample to determine one or more perturbations to optimize a loss function of the unlearned model for testing model accuracy with respect to unlearned data;
generating a test sample by applying a norm-bound perturbation to each non-private feature of the selected sample with a norm-bound perturbation, leaving unperturbed each private feature of the selected sample unperturbed; and
executing the unlearned model on the test sample to determine a predictive accuracy of the unlearned model.

18. The computer program product of claim 14, wherein the performance metrics provide a predetermined measure of at least one of prediction accuracy, privacy risk, and fairness associated with the unlearned model and the machine learning model.

19. The computer program product of claim 14, wherein the program instructions are executable by the processor to cause the processor to execute operations further including:
generating a JS-divergence between predictions generated by the unlearned model and the machine learning model, wherein the JS-divergence provides a performance metric measuring mitigation of influence of the selected sample on the unlearned model.

20. The computer program product of claim 14, wherein the program instructions are executable by the processor to cause the processor to execute operations further including:
generating a zero retrain forgetting (ZRF) score for the unlearned model, wherein the ZRF score provides a performance metric measuring mitigation of influence of the selected sample on the unlearned model.
